(19) United States
(12) Patent Application Publication
(10) Pub. No.: US 2021/0269968 A1
(43) Pub. Date: Sep. 2, 2021

(54) PRINTABLE FABRICS

(71) Applicant: HEWLETT-PACKARD DEVELOPMENT COMPANY, L.P., Spring, TX (US)

(72) Inventors: Xulong Fu, San Diego, CA (US); Xiaoqi Zhou, San Diego, CA (US); Douglas Knight, San Diego, CA (US)

(21) Appl. No.: 16/605,242

(22) PCT Filed: Jun. 29, 2018
(86) PCT No.: PCT/US2018/040173

§ 371 Date: Oct. 15, 2019

(51) Int. Cl. D06P 5/30; B32B 5/02; B32B 5/08; B32B 5/14; B32B 5/26; D06M 17/10

(52) U.S. Cl. CPC D06P 5/30; B32B 2307/75; B32B 5/024; B32B 5/028; B32B 5/08; B32B 5/14; B32B 5/26; D06M 17/10; B32B 2255/02; B32B 2262/023; B32B 2262/0246; B32B 2262/0292; B32B 2307/41; B32B 2307/718; B32B 2307/584; B32B 5/022

(57) ABSTRACT

A printable fabric can include a blockout fabric and from 1 gsm to 6 gsm of a discontinuous crosslinked polymer network on an outermost surface of the blockout fabric. The blockout fabric can include an inner fabric layer having a first side and a second side, wherein the inner fabric layer includes from 80 wt % to 100 wt % dark fibers; a first outer fabric layer attached to the first side and including from 80 wt % to 100 wt % light fibers; and a second outer fabric layer attached to the second side and including from 80 wt % to 100 wt % light fibers.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for various applications, such as textile printing. Textile printing can be used, for example, in the creation of signs, banners, artwork, apparel, wall coverings, window coverings, upholstery, pillows, blankets, flags, tote bags, clothing, etc.

### BRIEF DESCRIPTION OF DRAWINGS

FIG. 1 is a schematic cross-sectional view of example portions of a printable fabric in accordance with examples of the present disclosure;

FIG. 2 is a schematic view of a dip-coating and drying/crosslinking process that can be used to prepare a printable fabric in accordance with examples of the present disclosure;

FIG. 3 is a flow diagram depicting an example method of making a printable fabric in accordance with examples of the present disclosure;

FIG. 4 is a flow diagram depicting an example method of printing on a printable fabric in accordance with examples of the present disclosure; and

FIG. 5 is a graph of data collected for different discontinuous crosslinked polymer networks present on blockout fabrics in accordance with examples of the present disclosure.

### DETAILED DESCRIPTION

The nature of fabric can present challenges with respect to providing a printable surface(s) for acceptable print properties, e.g., high image quality, good durability, low fabric bleed-through, etc. For example, many natural fiber fabrics tend to be very absorptive leading to low optical density or color gamut, bleed, poor edge acuity, etc. Alternatively, some synthetic fiber fabrics can be crystalline, decreasing the ability of aqueous inks to absorb, which can also lead to bleed as well as poor print ink durability and/or other issues. Still further, some fabrics may not have enough opacity to enable printing on one side without the ink bleeding through to the other side. To achieve some or all of these acceptable print properties, ink-receiving layers can be included on fabrics. However, there are competing fabric properties that can be diminished when using one of the many types of ink-receiving layers often used for more traditional print media, namely fabric feel. In other words, though ink-receiving layers can provide acceptable print properties, they can also introduce unacceptable fabric feel, e.g., handleability, hand softness, foldability, wrinkle resistance, and/or other fabric feel properties fabric users have come to expect. For example, fabric users may want to be able to fold printed fabric for shipping and/or storage without introducing excessive wrinkling or damaging the print on the fabric surface. Thus, sometimes, acceptable print properties can be achieved at the expense of fabric feel, and/or vice versa. In further detail, even if acceptable print properties can be achieved to some degree with acceptable fabric feel, bleed-through can be an issue that can occur with thinner fabrics.

In accordance with this, the present disclosure is drawn to a printable fabric, which can include a blockout fabric having an inner fabric layer with a first side and a second side, the inner fabric layer including from 80 wt % to 100 wt % dark fibers. The blockout fabric can also include a first outer fabric layer attached to the first side and including from 80 wt % to 100 wt % light fibers, and a second outer fabric layer attached to the second side and including from 80 wt % to 100 wt % light fibers. The printable fabric can also include from 1 gsm to 6 gsm of a discontinuous crosslinked polymer network on to an outermost surface of the blockout fabric. In one example, the inner fabric layer can have a thickness from 50 μm to 150 μm, the first outer fabric layer can have a thickness from 50 μm to 150 μm, and the second outer fabric layer can have a thickness from 50 μm to 150 μm. The blockout fabric can have an opacity from 99% to 100% (based on TAPPI 425 methodology). The discontinuous crosslinked polymer network can be on both the first outer fabric layer and the second outer fabric layer in one example. The discontinuous crosslinked polymer network can alternatively have a coat weight of 1 gsm to 3 gsm. The discontinuous crosslinked polymer network can include a crosslinked polyurethane, a crosslinked epoxy, or both. Furthermore, the discontinuous crosslinked polymer network can further include polymer other than crosslinked epoxy and crosslinked polyurethane. In still another example, the discontinuous crosslinked polymer network can include both crosslinked polyurethane and crosslinked epoxy.

In another example, a method of making a printable fabric can include applying an aqueous fluid including 1 wt % to 5 wt % crosslinkable material to an outermost surface of a blockout fabric, and exposing the aqueous fluid applied to the blockout fabric to heat at from 40° C. to 180° C., electromagnetic radiation, or both the heat and the electromagnetic radiation to cause the crosslinkable material to form a discontinuous crosslinked polymer network at the outermost surface. The blockout fabric can include an inner fabric layer having a first side and a second side, with the inner fabric layer including from 80 wt % to 100 wt % dark fibers. The blockout fabric can also include a first outer fabric layer attached to the first side and including from 80 wt % to 100 wt % light fibers, and a second outer fabric layer attached to the second side and including from 80 wt % to 100 wt % light fibers. Application of the aqueous fluid to the blockout fabric can include dip coating the blockout fabric and removing excess aqueous fluid from the outermost surface. The crosslinkable material can include from 1 wt % to 25 wt % crosslinking agent, from 30 wt % to 89 wt % crosslinkable polymer reactive with the crosslinking agent, and from 10 wt % to 70 wt % self-crosslinkable polymer. To be clear, these crosslinkable material weight percentages are relative weight percentages within the 1 wt % to 5 wt % crosslinkable material content. In further detail, method can further include calendering the aqueous fluid applied to the blockout fabric at a pressure from 100 psi to 3,000 psi.

In another example, a method of printing on a printable fabric can include ejecting a latex-based pigmented ink composition onto a discontinuous crosslinked polymer network applied to a surface of a blockout fabric. The blockout fabric can include an inner fabric layer having a first side and a second side with the inner fabric layer including from 80 wt % to 100 wt % dark fibers, a first outer fabric layer attached to the first side and including from 80 wt % to 100 wt % light fibers, and a second outer fabric layer attached to the second side and including from 80 wt % to 100 wt % light fibers. In one example, the discontinuous crosslinked polymer network can be present on the surface at a coat weight of 1 gsm to 6 gsm.

It is noted that when discussing the printable fabrics or the methods herein, description in any of these contexts is considered applicable to other examples whether or not they are explicitly discussed in the context of that example. Thus, for example, in discussing a discontinuous crosslinked polymer network related to the printable fabrics, such disclosure is also relevant to and directly supported in context of the methods, and vice versa.

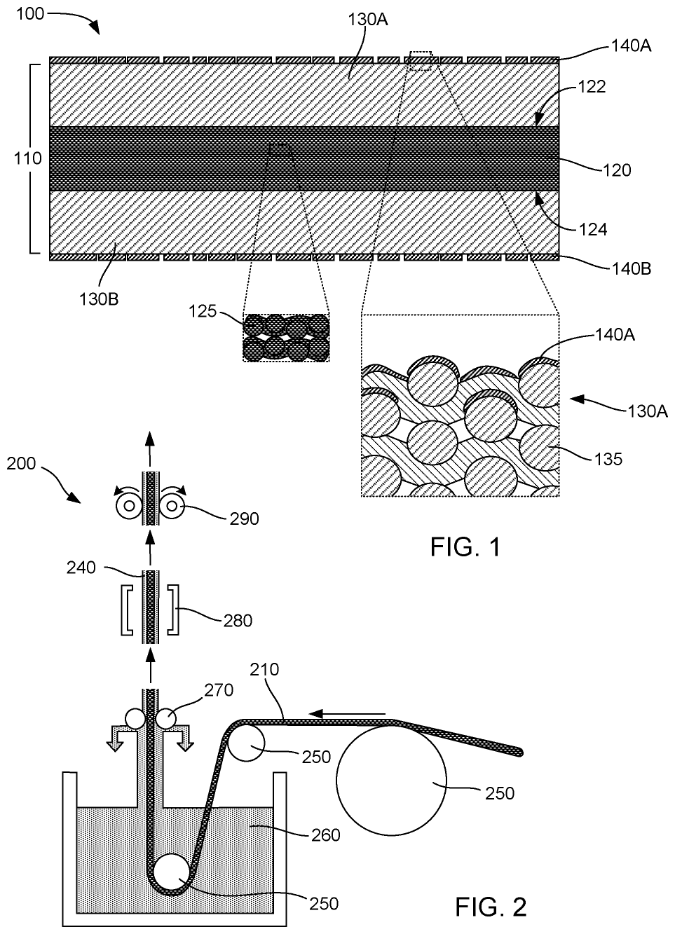

Turning now to FIG. 1, an example partial cross-sectional view of a printable fabric 100 prepared in accordance with examples of the present disclosure is shown. In this example, a blockout fabric 110 can include an inner fabric layer 120 and outer fabric layers 130A,130B, and can further include a discontinuous crosslinked polymer network 140A,140B thereon, respectively. The term “blockout fabric” as used herein can be a layered fabric that has an opacity of 95% to 100%, from 98% to 100%, from 99% to 100%, or in one example, 100%. Thus, the term “blockout” refers to the fabric's ability to prevent most if not all light from passing therethrough based on the opacity percentage ranges. For a fabric sample, which in examples herein is a layered fabric sample, opacity can be determined using the TAPPI 425 method. This opacity evaluative method is based on the proposition that the reflectance of media when stacked with a white backing is higher than that of media when stacked with a black backing, e.g., any light transmitted through an imperfectly opaque media sample, e.g., fabric, is partially reflected by the white backing, thus increasing the total reflection. More specifically, to determine if a fabric sample has an opacity ranging from 95% to 100%, or within one of the other opacity ranges provided herein, a contrast ratio can be determined based on a ratio of measured diffuse reflection the fabric being stacked with a black backing (0.5% reflectance or less), or “R0,” compared to the measured diffuse reflection of the same fabric stacked with a highly reflective white backing (89% reflectance), or “R0.89.” The resulting ratio value (R0/R0.89) can then be multiplied by 100 to arrive at the opacity percentage of the fabric (C0.89), in accordance with Formula I, as follows:

C0.89=100(R0/R0.89) Formula I

Thus, a contrast ratio of 100% defines an opaque fabric that does not allow light to pass therethrough (note, this may be a few percentage points off for transparent media samples, which is not the case at the high end of the opacity scale, e.g., at or near 100%).

Returning now to the construction of the printable fabric 100 of FIG. 1, the inner fabric layer 120 can have a first side 122 and a second side 124 to which two outer fabric layers 140A,140B can be attached, respectively. The inner fabric layer can include 80 wt % to 100 wt % dark fibers 125. The term “dark fibers” can be defined as any type of fibers, e.g., yarn, thread, etc., having an L* value from 5 to 40. The blockout fabric can also include outer fabric layers, namely a first outer fabric layer 130A and a second outer fabric layer 130B. The first outer fabric layer can be attached to the first side of the inner fabric layer and the second outer fabric layer can be attached to the second side of the inner fabric layer, such as by connection fibers, e.g., threads, yarns, etc., along the z-axis or direction (where the fabrics are essentially flat in the z-direction and occupy area along the x- and y-axes). The x- and y-geometries of the blockout fabric (or the individual fabric layers) can be of any geometry applicable to a specific application, e.g., the x- and y-axes shapes can be customized. The first and second outer fabric layers can both include from 80 wt % to 100 wt % light fibers 13. The term “light fibers” can be defined as any type of fibers, e.g., yarn, thread, etc., having an L* value from 70 to 100. The first and second outer fabric layers can be the same fabric, or can be unique relative to one another, but both can be light in color as defined by their L* values. Also shown in FIG. 1 is a first discontinuous crosslinked polymer network 140A attached to a surface of the first outer fabric layer. In this specific example, a second discontinuous crosslinked polymer network 140B is attached to a surface of the second outer fabric layer, which can provide for two-sided printing in some examples. Though shown on both sides, it is understood that a discontinuous crosslinked polymer network can be on one side or on both sides.

Turning to FIG. 2, an example system 200 for application of a discontinuous crosslinked polymer network 240 to a blockout fabric 210 is shown. In this example, the discontinuous crosslinked polymer network can be applied by dip coating the blockout fabric in an aqueous fluid 260 which includes from 1 wt % to 5 wt % crosslinkable materials using a series of application rollers 250. By using a low concentration of crosslinkable materials in the aqueous fluid, a low gsm discontinuous layer of crosslinked polymer can be formed, which upon application of heat (and in some cases pressure), forms the discontinuous crosslinked polymer network such as that shown at 140A in FIG. 1. Example low gsm weights for the discontinuous crosslinked polymer network can be from 1 gsm to 6 gsm, from 1 gsm to 5 gsm, from 1 gsm to 4 gsm, from 1 gsm to 3 gsm, or from 2 to 3 gsm.

Further in FIG. 2, the dip coating apparatus can be, for example, a multi-nip dip coater with multiple, e.g., two, nips 270 for removing excess aqueous fluid from the blockout fabric. The aqueous fluid on the surface of the blockout fabric 210 can then be treated to dry (to remove volatiles such as the water) and cause the crosslinkable polymers of the aqueous fluid to become crosslinked and form the discontinuous crosslinked polymer network 240. Any of a number of apparatuses can be used to accomplish both of these results, such as a dryer 280, a calenderer 290, and/or the like. The dryer can be, for example, a radiant heat dryer, a forced air dryer, IR dryer, or a combination thereof. In one example, drying can occur under heat for a period of time suitable to cause the crosslinkable material from the aqueous fluid to form a discontinuous crosslinked polymer network on the surface of the blockout fabric, as well as to remove water therefrom. In some examples, suitable temperatures can be from 40° C. to 180° C., from 50° C. to 150° C., 70° C. to 120° C. Time frames for drying can range from 30 seconds to 1 hour, from 1 minute to 30 minutes, from 5 minutes to 25 minutes, or from 10 minutes to 20 minutes, for example. Removal of the water content can be to levels where the remaining discontinuous crosslinked polymer network applied to the surface of the blockout fabric has a water content of 0 wt % to 8 wt %, from 1 wt % to 5 wt %, or from 2 wt % to 4 wt %, for example. With more specific reference to the calenderer, this device can apply pressure, heat, or both. In one example, pressure is applied at room temperature, and in another example, pressure is applied at elevated temperatures, e.g., 40° C. to 180° C., from 50° C. to 150° C., 70° C. to 120° C. The pressure applied by the calenderer can be by multiple, e.g., two, soft-nips which can apply the pressure at from 100 psi to 3,000 psi, from 200 psi to 2,000 psi, from 300 psi to 1,000 psi, from 100 psi to 1,000 psi, or from 1,000 psi to 3,000 psi, for example. Other calendering devices can likewise be used, such as flat press calenderers, or the like. Thus, heat can be applied using the heater, the calenderer, or both. Additionally, if pressure is applied, then it can be applied by the calenderer, for example. The heater and the calenderer can be used alone or in combination with the other sequentially, or reverse sequentially as that shown in FIG. 2.

Turning to more specific detail regarding the various fabric layers that can be used for the blockout fabric, it is initially noted that there are two types of fabric layers that can be present, e.g., an inner fabric layer and an outer fabric layer. The “inner fabric layer” can be dark in color, black, dark gray, etc., based on the L* values of the fibers used to prepare the inner fabric layer. For example, the inner fabric layer can include from 80 wt % to 100 wt % dark fibers, from 90 wt % to 100 wt % dark fibers, 95 wt % to 100 wt % dark fibers, or 100 wt % dark fibers. The term “dark” can refer to any color, gray, or black that has an L* value up to 40, from 5 to 40, from 5 to 30, from 5 to 20, or from 5 to 10, for example. The term “inner” indicates the positioning between two (or more) other layers that may be present. The “outer fabric layer(s)” can be light in color, white, light gray, etc., based on the L* values of the fibers used to prepare the outer fabric layer(s). For example, the outer fabric layer can include from 80 wt % to 100 wt % light fibers, from 90 wt % to 100 wt % light fibers, 95 wt % to 100 wt % light fibers, or 100 wt % light fibers. The term “light” can refer to any color, gray, or black that has an L* value from 70 to 100, from 80 to 100, from 90 to 100, from 95 to 100, or from 98 to 100, for example. The term “outer” fabric layer indicates the positioning closer to a surface of the blockout fabric relative to the “inner” fabric layer. In some examples, the outer fabric layer(s) can be outermost fabric layer(s). An “outermost” fabric layer refers to positioning relative to other fabrics, and does not include any non-fabric coating or layer that may be applied to the “outermost fabric layer(s).”

The term “L*” or “L* value” refers to the lightness of color (or gray) and ranges from 0 to 100, with 0 being at the darkest end of the scale (black) and 100 being at the lightest end of the scale (white). L* measurements herein are based on the CIE L*a*b* color space scale, and the L* value does not per se provide red-green (a*) or blue-yellow (b*) information, but rather is a way of quantifying lightness vs. darkness. L* is measured in the present disclosure using X-Rite, condition D65, 2 degrees. D65 refers to the CIE standard illuminant defined by the International Commission on Illumination (CIE) (at filing date hereof—ISO 10526:1999/CIE S005/E-1998).

In further detail, the inner fabric layer can have a thickness from 50 μm to 150 μm, from 60 μm to 125 μm, or from 75 μm to 110 μm; the first outer fabric layer can have a thickness from 50 μm to 150 μm, from 60 μm to 125 μm, or from 75 μm to 110 μm; and the second outer fabric layer can have a thickness from 50 μm to 150 μm, from 60 μm to 125 μm, or from 75 μm to 110 μm. In another example, the blockout fabric can have a basis weight from 150 gsm to 450 gsm, from 200 gsm to 400 gsm, or from 250 gsm to 350 gsm.

Any of the fabric layers of the blockout fabric can be from various types of fibers. The general term “fibers” includes any textile material, including treated or untreated as well as natural or synthetic fibers, example natural fibers can be from wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers can include polymeric fibers such as, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the synthetic fiber can be a modified fiber from the above-listed polymers. The term “modified fiber” refers to one or both of the polymeric fiber and the fabric as a whole having undergone a chemical or physical process such as, but not limited to, one or more of a copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation. The term “PVC-free fibers” as used herein means that no polyvinyl chloride (PVC) polymer or vinyl chloride monomer units are in the fibers. The fabric layers can also be a combination of fiber types, e.g. a combination of any natural fiber with another natural fiber, any natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber. The relative weight ratios of the various fiber types can vary. For example, if a combination of natural and synthetic fiber, the natural fiber can be present at from about 5 wt % to about 95 wt % and the synthetic fiber can range from about 5 wt % to 95 wt %. In yet another example, the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Alternatively, the ratio of natural fiber to synthetic fiber in the fabric layer can vary. For example, the ratio of natural fiber to synthetic fiber can be from 1:20 to 20:1, from 1:10 to 10:1, from 1:5 to 5:1, from 1:2 to 2:1, etc.

In further detail regarding the fabric layers, the fabric layers can include a substrate, and in some examples can be treated, such as with a coating that includes a calcium salt, a magnesium salt, a cationic polymer, or a combination of a calcium or magnesium salt and cationic polymer. Fabric layers can include substrates that have fibers that may be natural and/or synthetic, but in some examples, the fabric is particularly useful with natural fabric layers. The fabric layer can include, for example, a textile, a cloth, a fabric material, fabric clothing, or other fabric product suitable for applying ink, and the fabric layer can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric layer” does not include materials commonly known as any kind of paper (even though paper can include multiple types of natural and synthetic fibers or mixtures of both types of fibers). Fabric layers can include textiles in filament form, textiles in the form of fabric material, or textiles in the form of fabric that has been crafted into a finished article (e.g. clothing, blankets, tablecloths, napkins, towels, bedding material, curtains, carpet, handbags, shoes, banners, signs, flags, etc.). In some examples, the fabric layer can have a woven, knitted, non-woven, or tufted fabric structure. In one example, the fabric layer can be a woven fabric where warp yarns and weft yarns can be mutually positioned at any angle such as an angle of about 90°. This woven fabric can include but is not limited to, fabric with a plain weave structure, fabric with twill weave structure where the twill weave produces diagonal lines on a face of the fabric, or a satin weave. In another example, the fabric layer can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric layer can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of two or more of these processes.

Regardless of the structure, in one example, the fabric layer can include natural fibers, synthetic fibers, or a combination thereof. Exemplary natural fibers can include, but are not limited to, wool, cotton, silk, linen, jute, flax, hemp, rayon fibers, thermoplastic aliphatic polymeric fibers derived from renewable resources (e.g. cornstarch, tapioca products, sugarcanes), or a combination thereof. In another example, the fabric layer can include synthetic fibers.

In addition the fabric layer can contain additives including, but not limited to, one or more of colorant (e.g., pigments, dyes, and tints), antistatic agents, brightening agents, nucleating agents, antioxidants, UV stabilizers, fillers and lubricants, for example. Alternatively, the fabric layer may be pre-treated in a solution containing the substances listed above before applying other treatments or coating layers.

To provide a more specific example of a blockout fabric, the blockout fabric can be a multilayer fabric with the various layers, e.g., the inner layer and two opposing outer layers, woven above one another. Though there are three layers specifically described, there can be additional layers as well, but the inner layer will be positioned between the two outer layers. In some examples, as mentioned, the outer layers may be positioned as “outermost” layers. Connection between the layers can be by connection yarns or by otherwise interlocking the fabric layers in the z-dimension (relative to the x- and y-dimension of the generally flattened fabric layers. With this type of interconnection between layers, delamination resistance of the fabric can be enhanced, and in some instances, labor related to stacking different layers on top of one another can be reduced. The combination of layers can be of any type of fibers, as mentioned, but in particular, yarns used to prepare the various fabric layers can be effective for use. The light- or dark-nature of the various layers can be as described previously.

With more detail regarding the types of polymer that can be used to form the discontinuous crosslinked polymer network, there can be one or more crosslinked polymer and in some cases, other polymer that may not be crosslinked. The crosslinked polymer can be prepared from a self-crosslinkable polymer that crosslinks upon application of heat, electromagnetic radiation, e.g., IR radiation, and in some cases pressure); or a crosslinkable polymer in combination with a crosslinking agent (also in some cases with the help of added heat, radiation, and/or pressure). In some examples, there may be a self-crosslinkable polymer, a crosslinkable polymer, and a crosslinking agent present in a common aqueous fluid for application to the blockout fabric and then crosslinking on the fabric to form the discontinuous crosslinked polymer network. For example, there may be from 1 wt % to 5 wt % of crosslinkable material in the aqueous fluid that is used to form a 1 gsm to 6 gsm discontinuous crosslinked polymer network. The term “crosslinkable material” can include any dissolved or dispersed crosslinkable compounds within the aqueous fluid that participate in forming the discontinuous crosslinked polymer network that remains on the blockout fabric after any polymerization and crosslinking that occurs, such as crosslinking agent, self-crosslinkable polymer, crosslinkable polymer, monomers, oligomers, reactive surfactants, or the like. Crosslinkable materials do not include components that may be present in the aqueous fluid to provide an acceptable environment for polymerization, such as water or other solvent(s), surfactant not polymerized into the network, etc. In one specific example, of the 1 wt % to 5 wt % crosslinkable material that may be present in the aqueous fluid, there may be from 1 wt % to 25 wt % crosslinking agent, from 30 wt % to 89 wt % crosslinkable polymer reactive with the crosslinking agent, and from 10 wt % to 70 wt % self-crosslinkable polymer.

Example polymers that may be present in the discontinuous crosslinked polymer network include, without limitation, crosslinked epoxides and/or crosslinked polyurethanes, as well as any of a number of polymers that may also be crosslinked as part of the discontinuous polymer network or that may be present within the discontinuous polymer network but not crosslinked thereto, e.g., in some cases entangled within the discontinuous crosslinked polymer network. If both the crosslinked polyurethane and the crosslinked epoxy are present, in one example, they can be present at a weight ratio from about 12:1 to about 1:12, from about 6:1 to about 1:6, from about 4:1 to about 1:4, or from about 2:1 to about 1:2, for example. If a self-crosslinkable polymer is used with crosslinkable polymer that uses a separate curing agent (which can be provided by the self-crosslinkable polymer), then the ratio of self-crosslinkable polymer to crosslinkable polymer can be from about 4:1 to about 1:4 or from about 3:1 to about 1:3, or from about 2:1 to about 1:2, for example. Example other polymers that can be used to form the discontinuous crosslinked polymer network can include ethylene-vinyl acetate (EVA) and ethylene/vinyl acetate/vinyl alcohol (VCE) elastomers, styrene-acrylic copolymer, vinyl-versatate copolymer, vinyl-acrylic copolymer, self-crosslinking acrylic emulsions, polyisobutylene backboned elastomer containing low levels of conjugated diene functionality, or the like.

The crosslinked polyurethanes can be from self-crosslinkable polyurethanes, or from crosslinkable polyurethanes and a crosslinking agent, such as dicumyl peroxide, tolylene disocyanate dimer, blocked isocyanate with blocking agent such as 1,2-propane diol, 2-ethylhexanol and methoxypropoxypropanol, polyaziridines, polycarbodiimides, polyisocyanates, or the like. Example polyurethethanes that can be present include, without limitation, polyurethanes, vinyl-urethanes, acrylic urethanes, polyurethane-acrylics, polyether polyurethanes, polyester polyurethanes, polycaprolactam polyurethanes, polyether polyurethanes, derivatives thereof, or combinations thereof. The crosslinked epoxy of the discontinuous crosslinked polymer network can be from a self-crosslinkable epoxy, or can be from a crosslinkable epoxy and a crosslinking agent such as, but not limited to, mercaptans, imidazoles, dicyandiamide, cyclic anhydrides, dicarboxylic acid anhydride, boron trifluoride-amine complexes, organic acid hydrazide, polyphenols, polyamine, polycycloaliphatic polyamine, polyaziridine, polymercaptan, or the like. Example epoxies that can be present include, without limitation, alkyl epoxy resins, epoxy emulsions, epoxy novolac resins, polyglycidyl resins, polyoxirane resins, polyacrylates polyamines, derivatives thereof, or combinations thereof.

With more specific detail with regard to the polyurethanes, in one example, the polyurethane can be hydrophilic. In further detail, the polyurethane can be formed by reacting an isocyanate with a polyol. Exemplary isocyanates used to form the polyurethane polymer can include toluenediisocyanate, 1,6-hexamethylenediisocyanate, diphenylmethanediisocyanate, 1,3-bis(isocyanatemethyl)cyclohexane, 1,4-cyclohexyldiisocyanate, p-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, m-xylenediisocyanate, tetramethylxylenediisocyanate, 1,5-naphthalenediisocyanate, dimethyltriphenylmethanetetraisocyanate, triphenylmethanetriisocyanate, tris(isocyanatephenyl)thiophosphate, and combinations thereof. Commercially available isocyanates can include Rhodocoat™ WT 2102 (available from Rhodia AG, Germany), Basonat® LR 8878 (available from BASF Corporation, N. America), Desmodur® DA, and Bayhydur® 3100 (Desmodur and Bayhydur available from Bayer AG, Germany). In some examples, the isocyanate can be protected from water. Exemplary polyols can include 1,4-butanediol; 1,3-propanediol; 1,2-ethanediol; 1,2-propanediol; 1,6-hexanediol; 2-methyl-1,3-propanediol; 2,2-dimethyl-1,3-propanediol; neopentyl glycol; cyclohexanedimethanol; 1,2,3-propanetriol; 2-ethyl-2-hydroxymethyl-1,3-propanediol; and combinations thereof. In some examples, the isocyanate and the polyol can have less than three functional end groups per molecule. In another example, the isocyanate and the polyol can have less than five functional end groups per molecule. In yet another example, the polyurethane can be formed from a polyisocyanate having at least two isocyanate functionalities and a polyol having at least two hydroxyl or amine groups. Exemplary polyisocyanates can include diisocyanate monomers and oligomers.

In one example, the polyurethane prepolymer can be prepared with a NCO/OH ratio from about 1.2 to about 2.2. In another example, the polyurethane prepolymer can be prepared with a NCO/OH ratio from about 1.4 to about 2.0. In yet another example, the polyurethane prepolymer can be prepared using an NCO/OH ratio from about 1.6 to about 1.8.

In one example, the weight average molecular weight of the polyurethane prepolymer can range from about 20,000 Mw to about 200,000 Mw as measured by gel permeation chromatography. In another example, the weight average molecular weight of the polyurethane prepolymer can range from about 40,000 Mw to about 180,000 Mw as measured by gel permeation chromatography. In yet another example, the weight average molecular weight of the polyurethane prepolymer can range from about 60,000 Mw to about 140,000 Mw as measured by gel permeation chromatography.

Exemplary polyurethane polymers can include polyester based polyurethanes, U910, U938 U2101 and U420; polyether based polyurethane, U205, U410, U500 and U400N; polycarbonate based polyurethanes, U930, U933, U915 and U911; castor oil based polyurethane, CUR21, CUR69, CUR99 and CUR991; and combinations thereof. (All of these polyurethanes are available from Alberdingk Boley Inc., North Carolina).

In some examples the polyurethane can be aliphatic or aromatic. In one example, the polyurethane can include an aromatic polyether polyurethane, an aliphatic polyether polyurethane, an aromatic polyester polyurethane, an aliphatic polyester polyurethane, an aromatic polycaprolactam polyurethane, an aliphatic polycaprolactam polyurethane, or a combination thereof. In another example, the polyurethane can include an aromatic polyether polyurethane, an aliphatic polyether polyurethane, an aromatic polyester polyurethane, an aliphatic polyester polyurethane, and a combination thereof. Exemplary commercially-available examples of these polyurethanes can include; NeoPac® R-9000, R-9699, and R-9030 (available from Zeneca Resins, Ohio), Printrite™ DP376 and Sancure® AU4010 (available from Lubrizol Advanced Materials, Inc., Ohio), and Hybridur® 570 (available from Air Products and Chemicals Inc., Pennsylvania), Sancure® 2710, Avalure® UR445 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure® 878, Sancure® 815, Sancure® 1301, Sancure® 2715, Sancure® 2026, Sancure® 1818, Sancure® 853, Sancure® 830, Sancure® 825, Sancure® 776, Sancure® 850, Sancure® 12140, Sancure® 12619, Sancure® 835, Sancure® 843, Sancure® 898, Sancure® 899, Sancure® 1511, Sancure® 1514, Sancure® 1517, Sancure® 1591, Sancure® 2255, Sancure® 2260, Sancure® 2310, Sancure® 2725, Sancure®12471, (all commercially available from available from Lubrizol Advanced Materials, Inc., Ohio), and combinations thereof.

In some examples, the polyurethane can be cross-linked using a crosslinking agent. In one example, the cross-linking agent can be a blocked polyisocyanate. In another example, the blocked polyisocyanate can be blocked using polyalkylene oxide units. In some examples, the blocking units on the blocked polyisocyanate can be removed by heating the blocked polyisocyanate to a temperature at or above the deblocking temperature of the blocked polyisocyanate in order to yield free isocyanate groups. An exemplary blocked polyisocyanate can include Bayhydur® VP LS 2306 (available from Bayer AG, Germany). In another example, the crosslinking can occur at trimethyloxysilane groups along the polyurethane chain. Hydrolysis can cause the trimethyloxysilane groups to crosslink and form a silsesquioxane structure. In another example, the crosslinking can occur at acrylic functional groups along the polyurethane chain. Nucleophilic addition to an acrylate group by an acetoacetoxy functional group can allow for crosslinking on polyurethanes including acrylic functional groups. In other examples the polyurethane polymer can be a self-crosslinked polyurethane. Self-crosslinked polyurethanes can be formed, in one example, by reacting an isocyanate with a polyol.

In another example, the crosslinked polymeric network can include an epoxy. The epoxy can be an alkyl epoxy resin, an alkyl aromatic epoxy resin, an aromatic epoxy resin, epoxy novolac resins, epoxy resin derivatives, and combinations thereof. In some examples, the epoxy can include an epoxy functional resin having one, two, three, or more pendant epoxy moieties. Exemplary epoxy functional resins can include Ancarez® AR555 (commercially available from Air Products and Chemicals Inc., Pennsylvania), Ancarez® AR550, Epi-rez™ 3510W60, Epi-rez™ 3515W6, Epi-rez™ 3522W60 (all commercially available from Hexion, Tex.) and combinations thereof. In some examples, the epoxy resin can be an aqueous dispersion of an epoxy resin. Exemplary commercially available aqueous dispersions of epoxy resins can include Araldite® PZ3901, Araldite® PZ3921, Araldite® PZ3961-1, Araldite® PZ323 (commercially available from Huntsman International LLC, Texas), Waterpoxy® 1422 (commercially available from BASF, Germany), Ancarez® AR555 1422 (commercially available from Air Products and Chemicals, Inc., Pennsylvania), and combinations thereof. In yet another example, the epoxy resin can include a polyglycidyl or polyoxirane resin.

In one example, the epoxy resin can be self-crosslinked. Self-crosslinked epoxy resins can include polyglycidyl resins, polyoxirane resins, and combinations thereof. Polyglycidyl and polyoxirane resins can be self-crosslinked by a catalytic homopolymerization reaction of the oxirane functional group or by reacting with co-reactants such as polyfunctional amines, acids, acid anhydrides, phenols, alcohols, and/or thiols.

In other examples, the epoxy resin can be crosslinked by an epoxy resin hardener. Epoxy resin hardeners can be included in solid form, in a water emulsion, and/or in a solvent emulsion. The epoxy resin hardener, in one example, can include liquid aliphatic amine hardeners, cycloaliphatic amine hardeners, amine adducts, amine adducts with alcohols, amine adducts with phenols, amine adducts with alcohols and phenols, amine adducts with emulsifiers, ammine adducts with alcohols and emulsifiers, polyamines, polyfunctional polyamines, acids, acid anhydrides, phenols, alcohols, thiols, and combinations thereof. Exemplary commercially available epoxy resin hardeners can include Anquawhite™ 100 (commercially available from Air Products and Chemicals Inc., Pennsylvania), Aradur® 3985 (commercially available from Huntsman International LLC, Texas), Epikure™ 8290-Y-60 (commercially available from Hexion, Tex.), and combinations thereof.

In one example, the crosslinked polymeric network can include an epoxy resin and the epoxy resin can include a water based epoxy resin and a water based polyamine. In another example, the crosslinked polymeric network can include a vinyl urethane hybrid polymer, a water based epoxy resin, and a water based polyamine epoxy resin hardener. In yet another example, the crosslinked polymeric network can include an acrylic-urethane hybrid polymer, a water based epoxy resin, and a water based polyamine epoxy resin hardener.

In addition to the polyurethanes and epoxies that may be included, other polymers may additionally or alternatively be included. In one specific example, the crosslinked polymeric network can include a polyacrylate. Exemplary polyacrylate based polymers can include polymers made by hydrophobic addition monomers that include, but are not limited to, C1-C12 alkyl acrylate and methacrylate (e.g., methyl acrylate, ethyl acrylate, n-propyl acrylate, isopropyl acrylate, n-butyl acrylate, isobutyl acrylate, sec-butyl acrylate, tert-butyl acrylate, 2-ethylhexyl acrylate, octyl acrylate, methyl methacrylate, ethyl methacrylate, n-propyl methacrylate, isopropyl methacrylate, n-butyl methacrylate, isobutyl methacrylate, sec-butyl methacrylate, tert-butyl methacrylate), and aromatic monomers (e.g., styrene, phenyl methacrylate, o-tolyl methacrylate, m-tolyl methacrylate, p-tolyl methacrylate, benzyl methacrylate), hydroxyl containing monomers (e.g., hydroxyethylacrylate, hydroxyethylmthacrylate), carboxylic containing monomers (e.g., acrylic acid, methacrylic acid), vinyl ester monomers (e.g., vinyl acetate, vinyl propionate, vinylbenzoate, vinylpivalate, vinyl-2-ethylhexanoate, vinylversatate), vinyl benzene monomer, C1-C12 alkyl acrylamide and methacrylamide (e.g., t-butyl acrylamide, sec-butyl acrylamide, N,N-dimethylacrylamide), crosslinking monomers (e.g., divinyl benzene, ethyleneglycoldimethacrylate, bis(acryloylamido)methylene), and combinations thereof. Polymers made from the polymerization and/or copolymerization of alkyl acrylate, alkyl methacrylate, vinyl esters, and styrene derivatives may also be useful. In one example, the polyacrylate based polymer can include polymers having a glass transition temperature greater than 20° C. In another example, the polyacrylate based polymer can include polymers having a glass transition temperature of greater than 40° C. In yet another example, the polyacrylate based polymer can include polymers having a glass transition temperature of greater than 50° C.

In a further example, a discontinuous crosslinked polymer network can include a styrene maleic anhydride (SMA). In one example, the SMA can include NovaCote 2000® (Georgia-Pacific Chemicals LLC, Georgia). In another example, the styrene maleic anhydride can be combined with an amine terminated polyethylene oxide (PEO), amine terminated polypropylene oxide (PPO), copolymer thereof, or a combination thereof. In one example, combining a styrene maleic anhydride with an amine terminated PEO and/or PPO can strengthen the polymeric network by crosslinking the acid carboxylate functionalities of the SMA to the amine moieties on the amine terminated PEO and/or PPO. The amine terminated PEO and/or PPO, in one example, can include amine moieties at one or both ends of the PEO and/or PPO chain, and/or as branched side chains on the PEO and/or PPO. In one example, utilizing an amine terminated PEO and/or PPO in combination with SMA can allow for the user to retain the glossy features of the SMA while eliminating the brittle nature of SMA. Exemplary commercially available amine terminated PEO and/or PPO compounds can include Jeffamine® XTJ-500, Jeffamine® XTJ-502, and Jeffamine® XTJ D-2000 (all available from Huntsman International LLC, Texas). In some examples, a weight ratio of SMA to the amine terminated PEO and/or PPO can range from about 100:1 to about 2.5:1. In another, a weight ratio of the SMA to the amine terminated PEO and/or PPO can range from about 90:1 to about 10:1. In yet another example, a weight ratio of the SMA to the amine terminated PEO and/or PPO can range from about 75:1 to about 25:1.

In accordance with examples of the present disclosure, the discontinuous crosslinked polymer network can include multiple crosslinked networks, e.g., a first crosslinked network and a second crosslinked network. In some examples, the first crosslinked polymeric network can be crosslinked to itself. In another example, the first crosslinked network can be crosslinked to itself and to the second polymeric network. In another example, the second crosslinked polymeric network can be crosslinked to itself. When the first crosslinked polymeric network and the second crosslinked polymeric network are not crosslinked to one another they can be entangled or appear layered onto one another. Regardless of the arrangement of the discontinuous crosslinked polymer network, e.g., one network, multiple networks (entangled, layered, or crosslinked to one another), due to the thin coating layer that is discontinuous, acceptable durability can be achieved while retaining acceptable levels of some (or in some cases all) of the hand-feel properties that are desirable to users accustomed to the feel, foldability, etc., of fabrics generally.

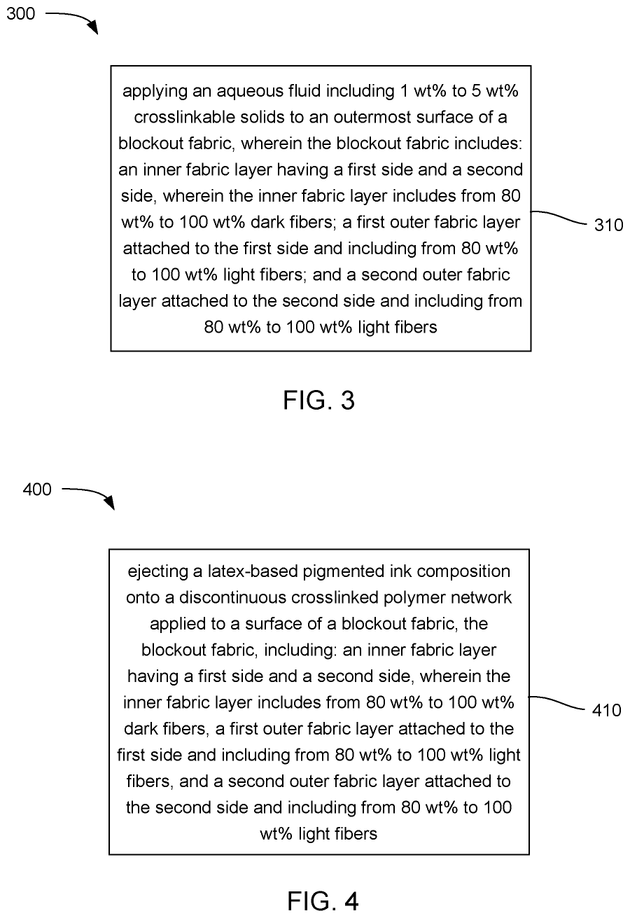

Turning now to various methods of the present disclosure, in FIG. 3, a method 300 of making a printable fabric, can include applying 310 an aqueous fluid including 1 wt % to 5 wt % crosslinkable material to an outermost surface of a blockout fabric. The blockout fabric can include an inner fabric layer having a first side and a second side, wherein the inner fabric layer includes from 80 wt % to 100 wt % dark fibers, a first outer fabric layer attached to the first side and including from 80 wt % to 100 wt % light fibers, and a second outer fabric layer attached to the second side and including from 80 wt % to 100 wt % light fibers. In one example, the method can further include exposing the aqueous fluid applied to the blockout fabric to heat, e.g., from 40° C. to 180° C., to cause the crosslinkable material to form a discontinuous crosslinked polymer network at the outermost surface. In one example, applying the aqueous fluid to the blockout fabric can be by dip coating and removing excess aqueous fluid from the outermost surface, e.g., using roller nips or some other device. The crosslinkable material content that makes up the 1 wt % to 5 wt % crosslinkable material in the aqueous fluid can be from 1 wt % to 25 wt % crosslinking agent, from 30 wt % to 89 wt % crosslinkable polymer reactive with the crosslinking agent, and from 10 wt % to 70 wt % self-crosslinkable polymer, in one example. In another example, the method can further include exposing the aqueous fluid applied to the blockout fabric to a pressure from 100 psi to 3,000 psi. The pressure can be used at the same time as the application of the heat, or can be used sequentially with the application of heat, or both, e.g., application of heat followed by application of heat and pressure.

In another example, a method 400 of printing on a printable fabric is shown in FIG. 4. The method of printing can include ejecting 410 a latex-based pigmented ink composition onto a discontinuous crosslinked polymer network applied to a surface of a blockout fabric. The blockout fabric can include an inner fabric layer having a first side and a second side, wherein the inner fabric layer includes from 80 wt % to 100 wt % dark fibers, a first outer fabric layer attached to the first side and including from 80 wt % to 100 wt % light fibers, and a second outer fabric layer attached to the second side and including from 80 wt % to 100 wt % light fibers. In this example, the discontinuous crosslinked polymer network can be present on the surface at a coat weight of 1 gsm to 6 gsm.

With respect to these methods, any of the descriptions related to the structure, compositions, assembly, arrangements, etc., herein are relevant to these methods.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is only exemplary or illustrative of the application of the principles of the presented formulations and methods. Numerous modifications and alternative methods may be devised by those skilled in the art without departing from the spirit and scope of the present disclosure. The appended claims are intended to cover such modifications and arrangements. Thus, while the technology has been described above with particularity, the following provide further detail in connection with what are presently deemed to be the acceptable examples.

### Example 1—Preparation of Blockout Fabric

Layered blockout fabrics were prepared using three layers of polyester fabrics, two outer layers were light in coloration (L* 83.7) and an inner layer was dark in coloration (L* 14.1). More specifically, the outer layer target coloration was white and the inner layer coloration was black. The fabrics were twill weaves from 100 wt % polyester yarns, and the total fabric weight was 265 gsm (all three layers being approximately the same in fabric weight of about 80-85 gsm per layer). The layered blockout fabrics were assembled using connection yarns to tie three layers together in the z-dimension. Once assembled, the layered blockout fabrics were prepared for application of the various discontinuous crosslinked polymer networks (printable layers) by scouring, heat setting, and whitening.

### Example 2—Preparation of Aqueous Fluids with Crosslinkable Polymer

Eight (8) different aqueous fluids (referred to in Tables 1A and 1B below as Fluid 1, Fluid 2, etc.), each containing about 2.3 wt % to about 2.4 wt % crosslinkable materials were prepared. The liquid vehicle used to carry the crosslinkable materials included 97.5 wt % water and about 0.1 wt % to about 0.2 wt % of an alcohol alkoxylate surfactant (BYK®-Dynwet 800, from BYK, Germany). The eight (8) aqueous fluid sample formulations are shown in Tables 1A and 1B, as follows:

TABLE 1A
Aqueous Fluid Samples with Crosslinkable Material

| | | Parts by Weight (at 2.5 wt % in water) | | | |
|---|---|---|---|---|---|
| Component | Type | Fluid 1 | Fluid 2 | Fluid 3 | Fluid 4 |
| Araldite ® PZ 3901 | Epoxy | 1 | 3 | 6.5 | 6.5 |
| (from Huntsman | Crosslinkable | | | | |
| International LLC) | Polymer | | | | |
| Aradur ® 3985 | Epoxy Curing | 1 | 3 | 3 | — |
| (from Huntsman | Agent | | | | |
| International LLC) | | | | | |
| Sancure ™ 2026 | Polyurethane | 6 | 6 | 6 | 6 |
| (Lubrizol Advanced | Crosslinkable | | | | |
| Materials) | Polymer | | | | |
| Sancure ™ AU4010 | Polyurethane Self- | 5 | 5 | 5 | 5 |
| (Lubrizol Advanced | crosslinkable | | | | |
| Materials) | Polymer | | | | |
| BYK ®-Dynwet 800 | Surfactant | 1 | 1 | 1 | 1 |
| (Byk) | | | | | |

TABLE 1B
Aqueous Fluid Samples with Crosslinkable Material

| | | Parts by Weight (at 2.5 wt % in water) | | | |
|---|---|---|---|---|---|
| Component | Type | Fluid 5 | Fluid 6 | Fluid 7 | Fluid 8 |
| Araldite ® PZ 3901 | Epoxy | 1 | 1 | — | 6.5 |
| (from Huntsman | Crosslinkable | | | | |
| International LLC) | Polymer | | | | |
| Aradur ® 3985 | Epoxy Curing | 1 | 1 | — | 6.5 |
| (from Huntsman | Agent | | | | |
| International LLC) | | | | | |
| Sancure ™ 2026 | Polyurethane | — | 11 | 6 | 6 |
| (Lubrizol Advanced | Crosslinkable | | | | |
| Materials) | Polymer | | | | |
| Sancure ™ AU4010 | Polyurethane Self- | 11 | — | 5 | 5 |
| (Lubrizol Advanced | crosslinkable | | | | |
| Materials) | Polymer | | | | |
| BYK ®-Dynwet 800 | Surfactant | 1 | 1 | 1 | 1 |
| (Byk) | | | | | |

*In this example, this surfactant is not considered to be a “crosslinkable solid” as defined herein. Thus, these formulations contain from about 2.3 wt % to about 2.4 wt % crosslinkable material.

### Example 3—Durability and Fabric Feel of Printable Fabrics

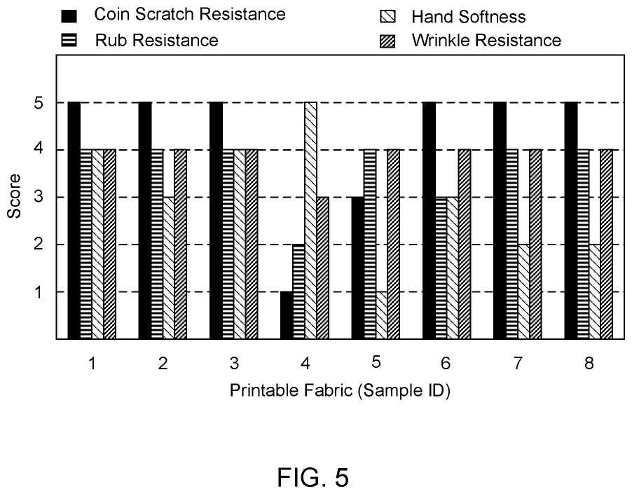

The (8) eight aqueous fluid samples of Example 2 were applied separately onto eight blockout fabric samples prepared in accordance with Example 1 by dip-coating using a two-nip dip coating padder. After dip-coating the blockout fabric with Fluids 1-8, respectively, they were dried using an oven at 120° C. for 15 minutes followed by a two-nip hard-soft-calender device at 60° C. at 2,000 psi. The moisture was brought to below about 5 wt % water. Thus, eight printable fabric samples were formed, which are referred to in Table 2 and FIG. 5 as Printable Fabric Samples 1-8, corresponding numerically with Fluids 1-8.

To arrive at the data shown in Table 2 and FIG. 5, eight printable fabric samples were printed with a latex-based pigmented inkjet ink at 100% fill, and then subjected to both durability testing, including Coin Scratch Resistance performance measured using a taber abrasion unit in accordance with ISO 1518:2011 (at the date of filing) using a round metal object (coin holder) dragged against the ink to demonstrate its resistance to removal (Taber Industries, 5750 linear abraser). Ink Rub Resistance was measured using a taber unit in accordance with ASTM F2497-05(2011)e1 (at the date of filing) using a cloth wrapped on one end of a solid cylinder surface that comes in contact on the ink and is rubbed back and forth 5 times at a weight ranging from 180 g to 800 g (Taber Industries, 5750 linear abraser, coil holder and cloth). Furthermore, Fabric Hand Softness was also tested to determine if the softness could be maintained using the raw (uncoated) fabric as a reference. Wrinkle Resistance was also evaluated by causing wrinkling and evaluating relative wrinkle recovery after 24 hours. Scores of 1 to 5 in Table 2 below, and as shown in FIG. 5, provide the data, with 1 indicating the worst performance and 5 indicating the best performance in the various categories. Every sample had an opacity of 100% based on the Tappi 425 methodology defined herein.

TABLE 2
Durability and Fabric Feel

| | | | | Wrinkle |
|---|---|---|---|---|
| | Coin Scratch | | Hand | Resistance |
| Printable | Resistance | Rub Resistance | Softness | 5 = wrinkle free |
| Fabric | 5 = no damage | 5 = no ink removed | 5 = least rigid | 1 = significant |
| (Sample ID) | 1 = all ink removed | 1 = all ink removed | 1 = most rigid | wrinkling |
| 1 | 5 | 4 | 4 | 4 |
| 2 | 5 | 4 | 3 | 4 |
| 3 | 5 | 4 | 4 | 4 |
| 4 | 1 | 2 | 5 | 3 |
| 5 | 3 | 4 | 1 | 4 |
| 6 | 5 | 3 | 3 | 4 |
| 7 | 5 | 4 | 2 | 4 |
| 8 | 5 | 4 | 2 | 4 |

As can be seen in Table 2 and in FIG. 5, the best performing discontinuous crosslinked polymer networks were Samples A and C, with B performing nearly as well. Other formulations still performed acceptably with respect to durability (coin scratch and rub resistance), except for Sample 4 which included a relatively high concentration of epoxy without a curing agent, thus the epoxy was present but not appropriately crosslinked. As a note, the crosslinkable epoxy and the crosslinkable polyurethane can crosslink with the self-crosslinkable polyurethane, but in this instance, there was a relatively significant excess of crosslinkable polymer compared to the self-crosslinkable polymer. Hand softness was good for most samples, with Samples 5, 7 and 8 underperforming, but still with acceptable durability. If hand softness is not a consideration, then Samples 5, 7 and 8 would be acceptable formulations for use. Hand softness may have been diminished to some degree due to the presence of only polyurethane at a relatively high concentration (Sample 7), or primarily only self-crosslinkable polyurethane with only a small amount of a crosslinkable polymer that is not self-crosslinkable (Sample 5), or due to the presence of significantly more crosslinkable material being used in the formulation (Sample 8). Wrinkle resistance was acceptable in every sample, with only slight relative underperformance of Sample 4, which included epoxy with no crosslinking agent suitable for the epoxy.

While the present technology has been described with reference to certain examples, those skilled in the art will appreciate that various modifications, changes, omissions, and substitutions can be made without departing from the spirit of the disclosure. It is intended, therefore, that the disclosure be limited only by the scope of the following claims.

What is claimed is:

1. A printable fabric, comprising:
a blockout fabric, including:
an inner fabric layer having a first side and a second side, wherein the inner fabric layer includes from 80 wt % to 100 wt % dark fibers,
a first outer fabric layer attached to the first side and including from 80 wt % to 100 wt % light fibers, and
a second outer fabric layer attached to the second side and including from 80 wt % to 100 wt % light fibers; and
from 1 gsm to 6 gsm of a discontinuous crosslinked polymer network on an outermost surface of the blockout fabric.

2. The printable fabric of claim 1, wherein the inner fabric layer has a thickness from 50 μm to 150 μm, the first outer fabric layer has a thickness from 50 μm to 150 μm, and the second outer fabric layer has a thickness from 50 μm to 150 μm.

3. The printable fabric of claim 1, having an opacity from 99% to 100%.

4. The printable fabric of claim 1, wherein the discontinuous crosslinked polymer network is on both the first outer fabric layer and the second outer fabric layer

5. The printable fabric of claim 1, wherein the light fibers are in the form of a light fiber yarn, and the dark fibers are in the form of a dark fiber yarn.

6. The printable fabric of claim 1, wherein the discontinuous crosslinked polymer network includes crosslinked polyurethane or crosslinked epoxy.

7. The printable fabric of claim 6, wherein the discontinuous crosslinked polymer network further includes polymer other than crosslinked epoxy and crosslinked polyurethane.

8. The printable fabric of claim 6, wherein the discontinuous crosslinked polymer network includes both crosslinked polyurethane and crosslinked epoxy.

9. A method of making a printable fabric, comprising applying an aqueous fluid including 1 wt % to 5 wt % crosslinkable material to an outermost surface of a blockout fabric, wherein the blockout fabric includes:
an inner fabric layer having a first side and a second side, wherein the inner fabric layer includes from 80 wt % to 100 wt % dark fibers;
a first outer fabric layer attached to the first side and including from 80 wt % to 100 wt % light fibers; and
a second outer fabric layer attached to the second side and including from 80 wt % to 100 wt % light fibers.

10. The method of claim 9, further comprising exposing the aqueous fluid applied to the blockout fabric to heat at from 40° C. to 180° C., electromagnetic radiation, or both the heat and the electromagnetic radiation to cause the crosslinkable material to form a discontinuous crosslinked polymer network at the outermost surface.

11. The method of claim 9, wherein applying is by dip coating the blockout fabric and removing excess aqueous fluid from the outermost surface.

12. The method of claim 9, wherein the crosslinkable material includes from 1 wt % to 25 wt % crosslinking agent, from 30 wt % to 89 wt % crosslinkable polymer reactive with the crosslinking agent, and from 10 wt % to 70 wt % self-crosslinkable polymer.

13. The method of claim 9, further comprising calendering the aqueous fluid applied to the blockout fabric to a pressure from 100 psi to 3,000 psi.

14. A method of printing on a printable fabric, comprising ejecting a latex-based pigmented ink composition onto a discontinuous crosslinked polymer network applied to a surface of a blockout fabric, the blockout fabric, including:
an inner fabric layer having a first side and a second side, wherein the inner fabric layer includes from 80 wt % to 100 wt % dark fibers,
a first outer fabric layer attached to the first side and including from 80 wt % to 100 wt % light fibers, and
a second outer fabric layer attached to the second side and including from 80 wt % to 100 wt % light fibers.

15. The method of claim 14, wherein the discontinuous crosslinked polymer network is present on the surface at a coat weight of 1 gsm to 6 gsm.
